(19) United States
(12) Patent Application Publication
(10) Pub. No.: US 2017/0197783 A1
(43) Pub. Date: Jul. 13, 2017

(54) COMPACTION RECEPTACLE

(71) Applicant: Compaction Technologies, Inc., Brooklyn Park, MN (US)

(72) Inventors: Luke Lundquist, Maple Grove, MN (US); James Faucher, Saint Michael, MN (US)

(21) Appl. No.: 15/401,754

(22) Filed: Jan. 9, 2017

Related U.S. Application Data
(60) Provisional application No. 62/276,049, filed on Jan. 7, 2016.

(51) Int. Cl. B65F 1/14

(52) U.S. Cl. CPC B65F 1/1405

(57) ABSTRACT

A compaction capable receptacle may include a housing with a trash receiving opening, a compaction unit arranged within the housing, and a trash bin arranged within the housing and configured for rotating trash within the bin below the compaction unit.

### RELATED APPLICATIONS

The present application claims priority to U.S. Provisional Application No. 62/276,049 entitled Compaction Receptacle and filed on Jan. 7, 2016, the content of which is hereby incorporated by reference herein in its entirety.

### FIELD OF THE INVENTION

The present disclosure relates to a compactor for compacting and temporarily storing debris. More particularly, the present disclosure relates to a compactor that is functional as a waste receptacle in a public setting. Still more particularly, the present disclosure relates to a publicly safe waste receptacle/compactor wherein the compaction head is arranged substantially within a compaction bin thereby providing for a relatively small design suitable for relatively small spaces.

### BACKGROUND

The background description provided herein is for the purpose of generally presenting the context of the disclosure. Work of the presently named inventors, to the extent it is described in this background section, as well as aspects of the description that might not otherwise qualify as prior art at the time of filing, are neither expressly nor impliedly admitted as prior art against the present disclosure.

Trash compactors are often used to minimize the volume of space that trash occupies. In some cases, trash compactors double as a waste receptacle and a compactor. In these cases, the compaction functionality of the receptacle may reduce the number of times that the receptacle needs to be emptied of trash.

In recent years, trash compactors have begun to be placed in public settings such that the volume of waste from public waste receptacles may be reduced in addition to reducing the number of times that such receptacles may need to be emptied. For example, in some cases, compaction-capable trash receptacles may be placed at various locations in amusement parks or public parks.

Given the public setting of these devices, at least two issues that have been addressed are safety and damage protection. That is, given the mechanical moving parts and the power of those parts for compaction, controls have been implemented to assure that users are prevented from reaching into or otherwise placing body parts in the path of the compaction head when the machine is compacting. Still further, user manipulation of the machines has also been reduced to avoid users damaging the machine through rough use. For example, in contrast to kitchen trash compactors of the past that included a trash bin that was part of an openable and closeable drawer, the public compactors are more akin to a public waste receptacle and little to no other external moving or manipulable parts.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

A compaction capable receptacle may include a housing with a trash receiving opening, a compaction unit arranged within the housing, and a trash bin arranged within the housing and configured for rotating trash within the bin below the compaction unit.

While various embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a perspective view of a compaction receptacle, according to one or more embodiments.

FIG. 2 is an exploded view of the compaction receptacle of FIG. 1, according to one or more embodiments.

FIG. 3 is a front/left perspective view of a frame of the compaction receptacle of FIG. 1, according to one or more embodiments.

FIG. 4 is a front/right perspective view of a frame of the compaction receptacle of FIG. 1, according to one or more embodiments.

FIG. 5 is a perspective view of a head portion of the compaction receptacle of FIG. 1, according to one or more embodiments.

FIG. 6 is an underside perspective view of the head portion of FIG. 5, according to one or more embodiments.

FIG. 7 is an underside perspective view of a ram of the head portion of FIG. 5, according to one or more embodiments.

FIG. 8 is a perspective view of a bin of the compaction receptacle of FIG. 1, according to one or more embodiments.

FIG. 9 is a perspective view of a dolly of the compaction receptacle of FIG. 1, according to one or more embodiments.

### DETAILED DESCRIPTION

The present disclosure, in some embodiments, relates to a compaction-capable trash receptacle that is suitable for use in relatively high trash volume venues such as fast food restaurants, amusement parks, state fairs and the like. The receptacle may include a compaction head that is arranged substantially within a portion of a trash/compaction bin. The receptacle may be configured for continuous feed operation which allows users to feed trash to the receptacle and into the bin whether the compaction head is in operation or not. However, a light curtain or other sensing mechanism or device may be provided to prevent the compaction head movement or compaction when user extremities are within the receptacle or in or around the compaction head. In some embodiments, the receptacle may be a top load receptacle where trash is received from an opening in the top of the receptacle. Still other advantages and features may be provided.

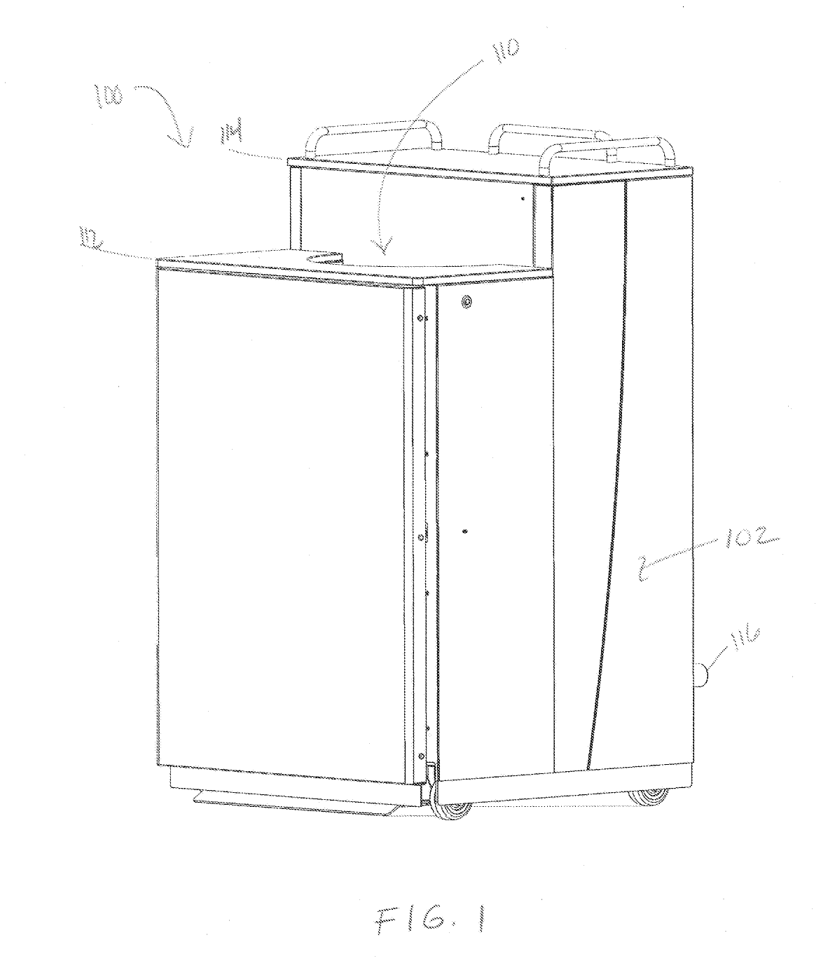

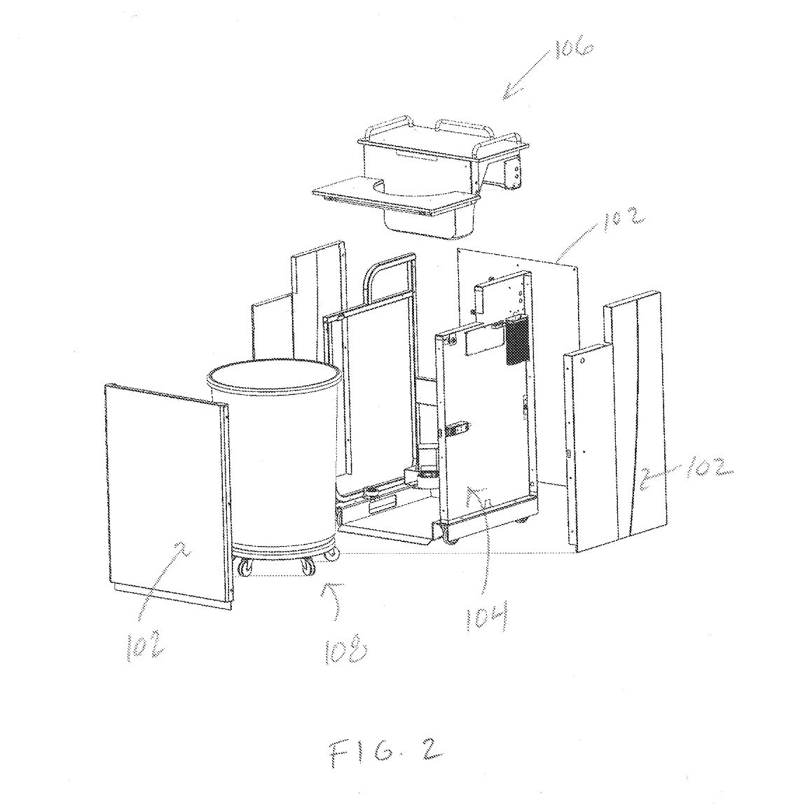

A compaction receptacle 100 is shown in FIGS. 1 and 2. The compaction receptacle 100 may be configured for placement in a public or semi-public venue and may be further configured to freely receive deposits of trash. The compaction receptacle 100 may also be configured to compact the deposited trash while simultaneously receiving such deposits of trash. The compaction receptacle 100 may be moveable by a user and may function much the same way current trash receptacles function, but may be much more efficient with respect to the volume of trash collected and/or the number of times the user may change out the trash bag or other container. As shown in FIGS. 1 and 2, the compaction receptacle 100 may include one or more housing panels 102, a frame portion 104, a head portion 106, and a trash collecting portion 108. Each of these portions are described in detail below.

With continued reference to FIGS. 1 and 2, the one or more housing panels 102 may be configured for enclosing the inner working systems and devices of the compaction receptacle 100. For example, the one or more housing panels 102 may be substantially solid panels for preventing access by users to the inside of the compaction receptacle 100. The panels 102 may, for example, be solid enough to prevent access by human limbs such as hands and arms and other similarly sized items from passing through the sidewalls of the compaction receptacle. Other than the opening for receiving trash 110, the housing panels 102 may be substantially solid, for example, around all four sidewalls of the compaction receptacle 100. The housing panels 102 may be relatively thin plate-like elements configured for being secured adjacent to the frame portion 104 of the receptacle 100. The housing panels 102 may have an aesthetically pleasing outer finish to provide for an aesthetic receptacle. The housing panels 102 may form a curtain, film, membrane, or other façade around the inner working elements of the compaction receptacle 100. The plate-like housing elements may have creases, recesses, seams, beveled edges, or other features helping to establish a desired appearance and/or defining shape.

The front housing panel 102 may be a substantially square or rectangular panel. The front housing panel 102 may extend upward along the front of the receptacle 100 to a table or desk level 112 where the compactor includes a trash receiving opening 110. The front housing panel 102 may be mounted to a frame or inner panel and may close off access to the front of the receptacle 100. The front housing panel 102 may be configured for opening and closing relative to the receptacle to allow access to the trash receiving bin and other features within the receptacle 100.

The side panels 102 may be substantially square or rectangular like the front panel, but may also include a stepped portion to accommodate and/or align with the table or desk level 112 and to also align with a shelf level 114 where, for example, the receptacle may have a tray receiving area. The side panels 102 may be mounted to an inner frame or inner panel and may close off access to the sides of the receptacle.

The back panel 102 may be substantially square or rectangular like the front panel 102. The back panel 102 may extend upward along the back of the receptacle to the shelf level 114 and, as such, may be slightly taller than the front panel 102. The back housing panel 102 may be mounted to a frame or inner panel and may close off access to the back of the receptacle. In one or more embodiments, the back panel may include one or a plurality of stoppers or standoff elements 116 allowing the compaction receptacle 100 to be placed against a wall, for example, while maintaining a gap between the receptacle 100 and the wall.

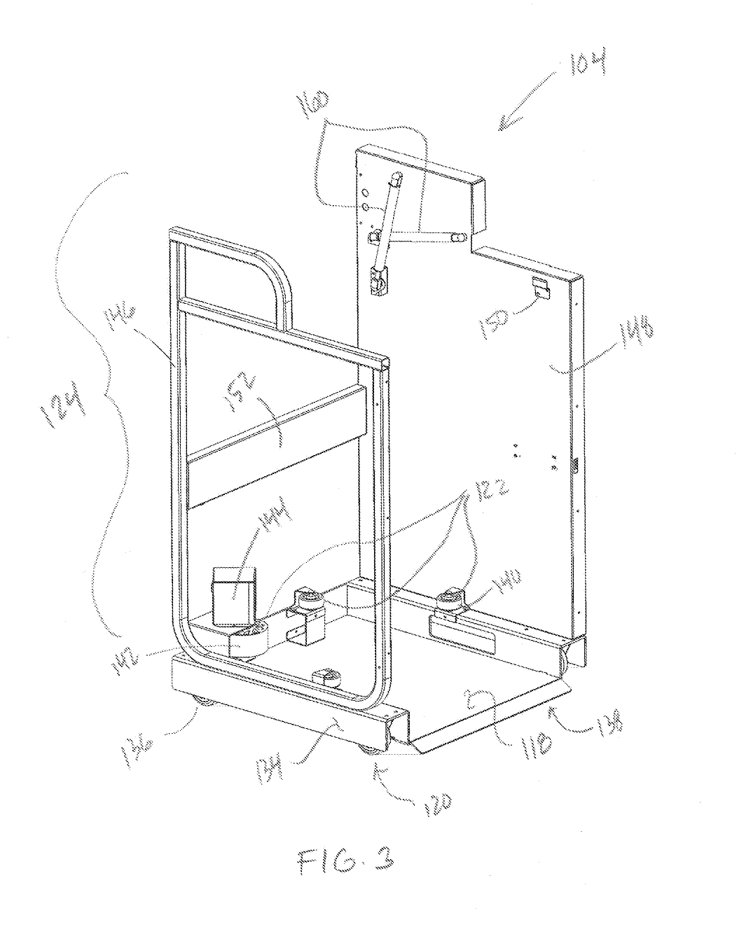

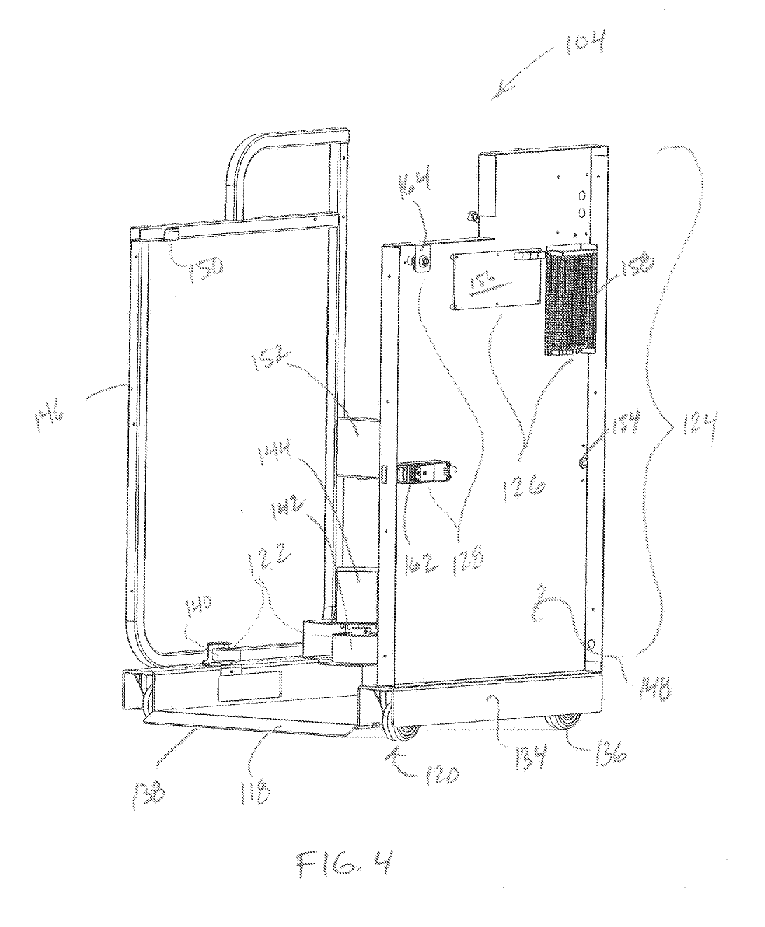

Turning now to the frame portion 104 mentioned above, FIGS. 3 and 4 show several features thereof. The frame portion 104 may be configured to form the shape or structure of the receptacle and hold or position several features in position to allow for interaction thereof and operation of the receptacle. Accordingly, several features may be described in conjunction with the frame portion 104. For example, the frame portion 104 may include a bottom or floor portion 118, a transport portion 120, a bin rotation system 122, an upright portion 124, a power and control system 126, and a lockout/access system 128.

The bottom or floor portion 118 may form the bottom of the receptacle 100. The bottom or floor portion 118 may be configured for receiving and supporting the bin 130, a dolly 132, or a bin/dolly combination. In addition, the bottom or floor portion 118 may support or be supported by the transportation portion 120 and may also hold portions of the bin rotation system 122 in position.

With respect to forming a bottom of the receptacle 100, the bottom or floor portion 118 may be a substantially solid element defining a bottom of an interior volume in which the bin 130 and/or dolly 132 is arranged. The bottom or floor portion 118 may be substantially solid to collect or catch liquids or solids or debris that may fall between the bin 130 and the housing 102.

With respect to supporting the bin 130 and/or dolly 132, in one or more embodiments, the bottom or floor portion 118 may include one or more fenders or wheel wells 134 extending along each side for accommodating a series of wheels, casters, or other supporting elements 136 bsuch as legs or pegs, for example. The fenders or wheel wells 134 may extend upward from the bottom or floor and may extend along each side of the bottom or floor in the form of an inverted channel, for example. In this embodiment, the inverted channel may accommodate a front and back supporting element 136 on each side of the floor. In other embodiments, the fenders or wheel wells 134 may be provided for each particular wheel or support element 136 and may form a cup or dome shape, for example.

The bottom or floor portion 118 may be relatively thick as compared to the housing panels, for example, and may span between the fenders or wheel wells 134. The bottom or floor portion 118 may have a substantially flat top surface allowing the bin 130 and/or dolly 132 to move readily across and around the bottom or floor portion 118. In other embodiments, the top surface of the bottom or floor portion may have a groove or slot for receiving the wheels of a bin 130 and/or dolly 132 so as to guide the wheels as the bin 130 and/or dolly 132 is rotated within the housing 102.

With respect to receiving the bin 130 and/or dolly 132, the bottom or floor portion 118 may have a mouth, ramp, guide, or other receiving feature 138 facing the front of the receptacle 100 allowing the bin 130 and/or dolly 132 to be easily inserted into the front of the receptacle 100. In one or more embodiments, the receiving feature 138 may include an extended portion of the bottom or floor portion that is bent or sloped downwardly toward the ground forming a ramp for rolling the bin 130 and/or dolly 132 up and onto the bottom or floor portion and into the receptacle 100. In other embodiments, the receiving feature may be separate piece such as a wedge, elevator, lever, or other element for accommodating entry of the bin 130 or dolly 132.

As mentioned, the bottom or floor portion 118 may include one or more fenders or wheel wells 134 for wheels, casters, or other support elements 136. These wheels, casters, or other support elements 136 may form all or a part of the transportation system 120 that allows the compaction receptacle 100 as a whole to be moved from one location to another. The support elements 136 may be secured to the top and/or sides of the fenders or wheel wells 134 and may function to hold the bottom or floor portion 118 up off of the ground allowing for clearance when moving the receptacle 100. In some embodiments, the transportation system 120 may be retractable and/or deployable such that the receptacle 100 may be placed with the bottom or floor portion 118 in contact with the ground when the transportation system 120 is retracted and the bottom or floor portion 118 may be lifted off of the ground when the transportation system 120 is deployed. In one or more embodiments, the transportation system 120 may be arranged on a deployable frame allowing all aspects of the transportation system 120 to be deployed simultaneously, for example. In one or more embodiments, the transportation system 120 may include wheel locks to prevent movement of the receptacle 100 when such is not desired.

The bottom or floor portion 118 may also support the bin rotation system 122. As shown, the bin rotation system 122 may include a series of bogie wheels or guides 140 for riding along the side of the bin 130, holding the bin 130 in position, and allowing the bin 130 to rotate relative to the receptacle 100. The bogie wheels 140 may include rubber, plastic, steel, nylon or other material wheels arranged to rotate about a vertical axis as shown. The wheels may include bearings or bushings allowing the wheels to rotate relatively freely about a vertically arranged shaft. Several bogie wheels or guides 140 may be provided along the perimeter of the bin 130 to maintain the position of the bin 130 but allow the bin 130 to rotate. While moving wheels have been described for guiding the rotation of the bin 130, static sliding type guides may also be used. Such guides 130 may include a radiused surface matching an outer surface radius of the bin 130, for example, so as to cup the side of the bin 130 and allow the bin 130 to rotate. The bogie wheels or guides 140 may be supported off of the floor or bottom portion with brackets as shown.

As also shown, the bottom or floor portion 118 may also support a drive wheel 142 that is configured to engage the side of the bin 130 and to selectively rotate the bin 130 as trash or debris is received. The drive wheel 142 may be arranged similar to the bogie wheels or guides 140, but may be in rotational communication with a motor 144 for driving the wheel 142 and the bin 130. The drive wheel 142 may be a rubber, plastic, steel, nylon, or other material wheel that is arranged to rotate about a vertical axis as shown. The wheel 142 may include a keyed or otherwise engaging element causing the wheel 142 to engage a drive shaft and allowing the wheel 142 to be driven by the motor 144. The drive wheel 142 may be positioned and arranged to engage the outside surface of the bin 130 to cause the bin 130 to rotate when the wheel 142 is rotated. The drive wheel 142 may also be supported off of the bottom or floor portion 118 by a bracket, for example.

In one or more embodiments, while the bin rotation system 122 has been said to be supported off of the bottom or floor portion 118, some or all of the bin rotation system 122 may be supported by other portions of the frame 104 or other portions of the receptacle 100. For example, one of the bogie wheels or guides 140 may be provided on the inside of the front panel 102. In other embodiments, the guides 140 or other aspects of the bin rotation system 122 may be provided in other locations.

The upright portion 124 of the frame 108 may include a series of upright frame elements and upright panel elements. In some embodiments, for example, a side of the frame may include a tubular frame 146 for supporting the head portion 106, resisting the mechanical forces of the compactor, and receiving the side panels 102. In some embodiments, another side of the frame may include a structural panel 148 for supporting the head portion 106, resisting the mechanical forces of the compactor, and receiving the side panel. Both the tubular frame side 146 and the structural panel side 148 may include a clip, stop, or other element 150 for supporting a front portion of the head portion 106 when it is in a closed position. The clip, stop, or other element 150 may extend inwardly from the tubular frame 146 or structural panel 148 and provide a catch point when the head portion 106 is pivoted downwardly allowing the front portion of the head 106 to rest thereon and arrest pivoting motion of the head portion 106.

In one or more embodiments, as shown, the back portion of the upright portion of the frame may include a cross member or electrical chase 152. As shown in FIG. 4, one or more grommets 154 or other protective elements may be provide through a side portion of the frame 104 to allow an electrical cord to pass therethrough and avoid damage. In other embodiments, a tubular frame may be provided across the back of the unit similar to the frame on the side of the unit.

One or both of the tubular frame 146, the structural panel 148, or the back portion may be configured for positioning of the power and control system, which may include a control circuit board 156 and a power supply 158 as shown in FIG. 4. The power supply 158 may be configured for supplying power to the system and the circuit board 156 may be configured to control operation of the system. For example, the circuit board 156 may control compaction cycles, how and when they occur, and may control prevention of such cycles in unsafe conditions. Accordingly, the circuit board 156 may be in electrical communication with a series of devices and/or sensors such as a light curtain in the head portion, the latches and locks for the front panel and the head portion, and trash/debris sensors relating to the amount of trash in the bin. Still other types of sensors and devices may be in electrical communication with the circuit board 156 for monitoring, activation, and deactivation of the system.

In one or more embodiments, one or both of the tubular frame 146, the structural panel 148, or the back panel may also include one or more cylinders or struts 160 for supporting the head portion 106 in an open position. The cylinders or struts 160 may support the weight of the head portion 106 in an open or pivoted up position. In one or more embodiments, a single cylinder 160 may be provided. In other embodiments, as shown, multiple cylinders 160 may be provided to allow for redundancy and to take advantage of varying angular orientations with respect to the position of the head 106 and the need to support the weight thereof.

The tubular frame 146 and/or the structural panel 148 may also include a lockout/access system 128. For example, as shown in FIG. 4, a front panel lock 162 may be provided and a key switch 164 may also be provided. In one or more embodiments, safety measures may be implemented to prevent use of the device where damage or injury could occur. For example, opening of the front panel 102 may cause the device to deactivate so as to avoid compaction cycles when the front panel 102 is open. In addition, the lifting or pivotal motion of the head 106 may not be available if the front panel 102 is closed. As such, unless the front panel 102 is closed, the head might not be capable of being pivoted upwardly and compaction cycles might not be able to be performed. The circuit board 156 mentioned may be in electrical communication with the lockout/access system 128 for some or all of these reasons.

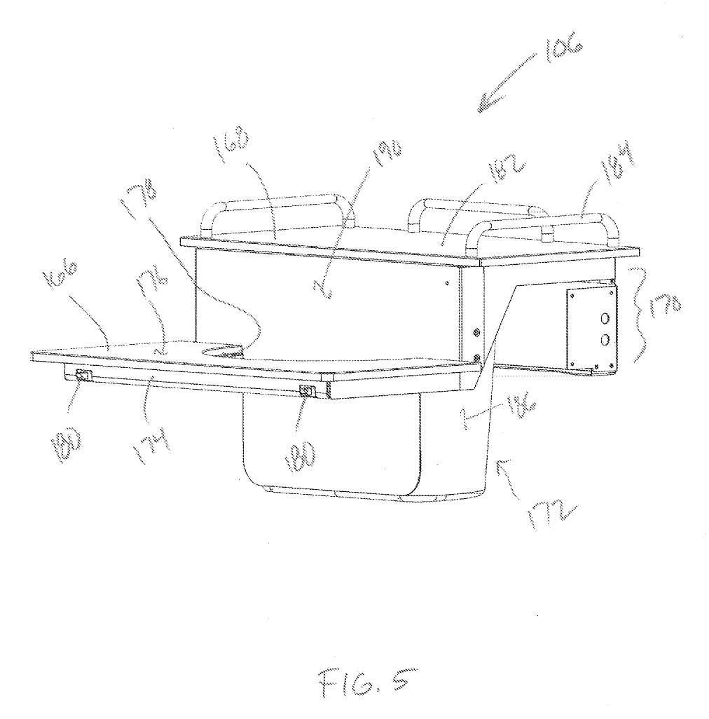

Turning now to the head portion 106, such is shown in FIGS. 5-7. The head portion 106 may be configured for receiving debris and/or trash, for selectively, regularly, or continuously compacting the trash, and for pivoting out of the bin at times of trash removal, bin removal, repair, cleaning, etc. In one or more embodiments, the head portion 106 may include a table top and/or trash receiving portion 166, a shelf portion 168, a connection portion 170, and a compactor portion 172.

The table top and/or trash receiving portion 166 may be selectively arranged on the frame portion 104 and may be positioned at or near the top of the bin 130 so as to limit or reduce the amount of trash or debris that may pass below the table top portion 166 and around the bin 130 without going in the bin 130. The table top and/or trash receiving portion 166 may include a frame engaging portion 174, a top surface 176, and a bin edge portion 178. The frame engaging portion 174 may include tubes, plates, pipes, or other framing members forming an outer edge of the table top portion 166 configured to engage a top edge of the frame portion 104. The frame engaging portion 174 may include one or more latches 180 for engaging the frame portion 104 and preventing opening of the head portion 106 when the front panel is closed, for example. In one or more embodiments, the head portion 106 may be closed before or after the front door of the frame portion 104 is closed. For example, the one or more latches 180 on the front of the head potion 106 may be beveled latches to allow the latches to retract upon engaging the front panel portion 102 and then project once the latches clear the upper edge of the front panel portion 102. The latches 180 may engage the front door portion 102 and prevent upward pivoting of the head portion 106, unless/until the front door portion 102 is opened. Since the front door portion 102 may be locked (i.e., by the lockout/access system 128), opening of the unit may be controlled by the owner or user by requiring the use of a key, for example, to open the front door, where opening of the front door may free up the head portion 106 allowing it to pivot upward, removing the ram portion from the bin 130 and clearing the bin 130 for removal from the receptacle 100.

The shelf portion 168 may be raised above the table top portion 166 and offset toward the rear of the receptacle 100. The shelf portion 168 may include a top surface 182 for receiving trays, for example, and may include boundary rails 184 to resist and/or prevent trays from sliding off of the shelf portion. The transition between the table top portion 166 and the shelf portion 168 may occur at or near the mid depth of the compaction receptacle 100 and the space below the shelf portion 168 and the top of the bin 130 may allow for portions of the compactor portion to be positioned.

The shelf portion 168 may extend rearward from the transition to the back of the receptacle 100 and may include a connection portion 170 in the form of a hinge or other pivoting connection to the frame portion 104 at the back of the receptacle 100. The hinge or other pivoting connection 170 may be biased in an up condition such that upon opening of the unit, the shelf portion 168 may rotate upwardly and out of the way automatically. As shown in FIG. 3, the head portion may be connected to the frame portion 104 with one or more struts, springs, or hydraulic pistons, 160 for example. Such struts, springs, or hydraulic pistons may be compressed when the head 106 is down and may extend when the head is unlatched from the frame portion 104 thereby causing the head portion 106 to rotate or pivot upward. Accordingly, upon freeing of the latches 180 on the front of the head portion 106 from the door 102, the head portion 106 may pivot upward automatically. Still other types of connection portions 170 may be provided such as other operable or disconnecting features to allow the ram portion of the head 106 to be removed from the bin 130 allowing the bin to be removed from the receptacle 100.

The compactor portion 172 may be arranged below the shelf portion 168 and to the rear of the table top portion 166. The compactor portion 172 may be configured for compacting debris or trash within the bin 130 and may be positioned in approximately the back half or back portion of the bin 130. In one or more embodiments, the compactor portion 172 may include a bin-accommodating housing 186 configured for engaging and/or nesting within the trash receiving bin 130. In one or more embodiments, the bin-accommodating housing 186 may include a substantially flat front surface and a substantially radiused back surface configured to model and/or match the inside radiused surface of the trash receiving bin. In one or more embodiments, the back surface may include a draft angle that is the same or similar to that of the bin 130. The bin-accommodating housing 186 may function to maintain the position of the bin 130 during compaction operations in addition to rotating operations. That is, while the wheels or guides 140 near the bottom of the unit may guide the bin 130 during rotation, the bin-accommodating housing 186 of the ram may slidingly guide a top portion of the bin 130 by engaging its inside surface.

A ram or extending element 188 may be arranged within the bin-accommodating housing 186 and may be configured to extend downwardly from the head portion 106 and into the bin to compact trash or debris within the bin 130. The ram or extending element 188 may be a hydraulic ram, a scissor-type ram, or other device for extending a ram head down into the bin 130. In one or more embodiments, the ram head may be substantially rectangular. In other embodiments, the ram head may have a relatively flat front edge and may include a radiused back edge to accommodate a radius inside surface of the bin 130. The ram or extending element may include a motor or pump 188 for actuating the ram depending on the type of ram being used.

It is to be appreciated that flexibility of the present system may be provided by allowing the ram 188 to be actuated at any time during operation including when debris is still being placed in the unit. That is, since the ram 188 is arranged in a back half of the bin, trash or debris may still be placed in the front of the bin during compaction operations. Accordingly, earlier issues of ram speed, timing of compaction cycles, length of compaction hold and the like may be avoided and may provide a wider range of options for the ram selection and the type of ram used. Accordingly, while hydraulic rams may be relatively slow, they may be relatively powerful and desirable. Still further, while a scissor-type ram may be relatively fast, they may not be as powerful in an extended position, for example. In one or more embodiments, a combination of ram types may be provided.

The head portion 106 may also include a backstop or wall 190 configured for forming a back portion of the trash receiving opening and guiding trash or debris downwardly into the bin 130 and protecting the compactor portion from debris, trash, and other potentially messy items. The backstop or wall 190 may be arranged on a front of the shelf portion 168, behind the trash receiving opening 110 and may be arranged substantially vertically. The backstop or wall 190 may be a substantially flat structure extending from a bottom of the shelf downward along the transition between the table top portion 166 and the shelf portion 168 and may extend through the trash receiving opening 110 downward and into the bin 130 and in front of the compactor portion 172. Accordingly, as trash is placed into the receptacle 100, the trash may encounter the backstop portion 190 and be guided or fall into the bin 130 below.

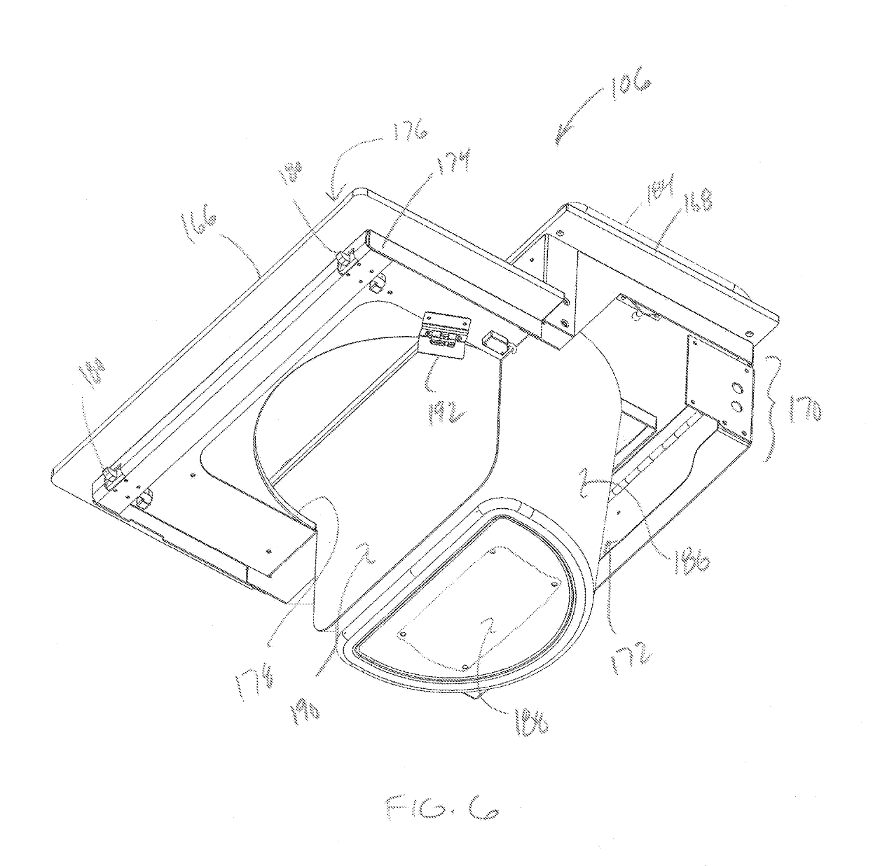

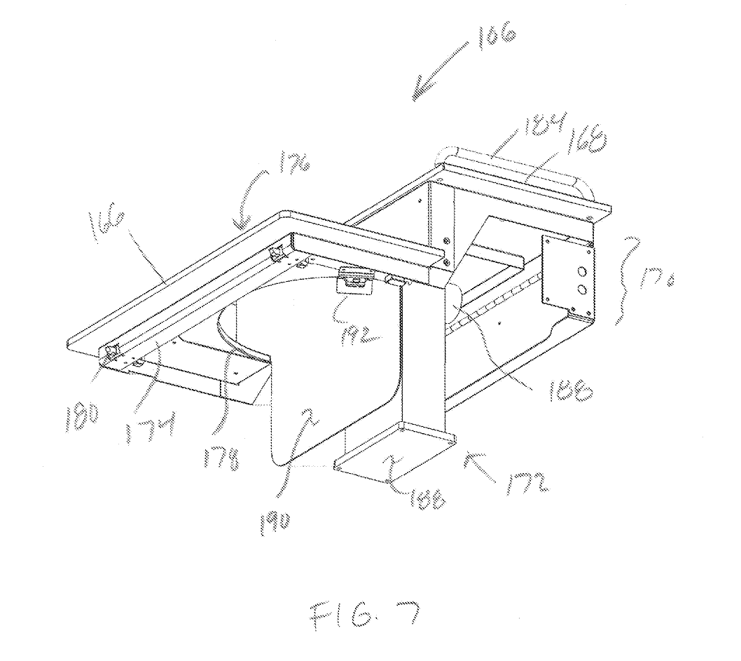

As shown in FIGS. 6 and 7, a light curtain 192 may be arranged below the table top portion 166 and may create light curtain that extends generally parallel to and below the trash receiving opening 110. The light curtain may be configured to recognize when obstructions have entered the trash receiving opening 110 and may function to interrupt, halt, stall, prevent or otherwise control the compactor portion 172 during those times to avoid injury, for example. The light curtain may be in communication with the board 156 and the board 156 may control the compactor portion 172 based, in part, on whether the light curtain has been interrupted or blocked.

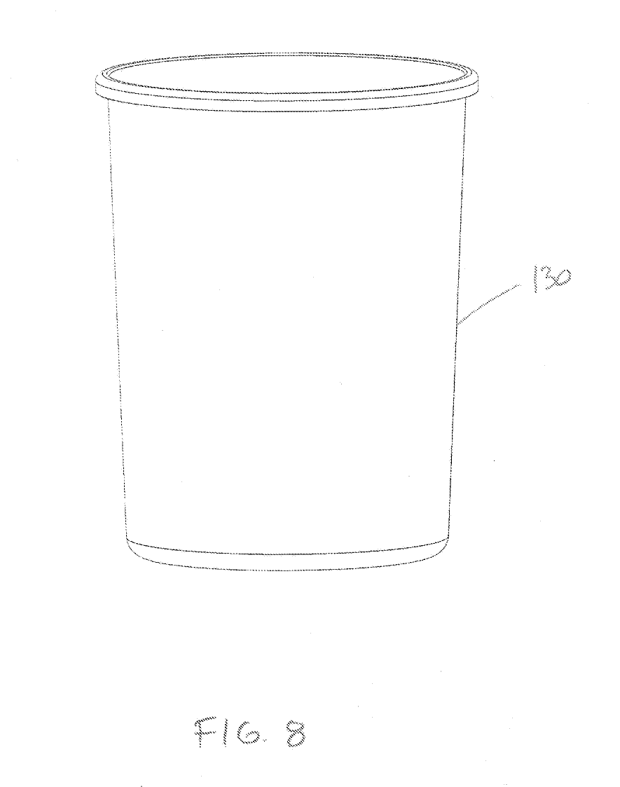

In FIG. 8, a bin 130 is shown. The present compaction receptacle 100 has been designed to accommodate relatively standard trash bins 130 to allow for use of bins 130 already on hand and to help avoid the need to replace trash bins 130 during implementation of compaction receptacles 100. In one or more embodiments, the bin 130 may be a substantially cylindrical trash bin with an upper rim, a bottom, and a draft angle. In one or more embodiments, the bin may be a 24 gallon bin, a 32 gallon bin, a 44 gallon bin, or another size bin may be provided.

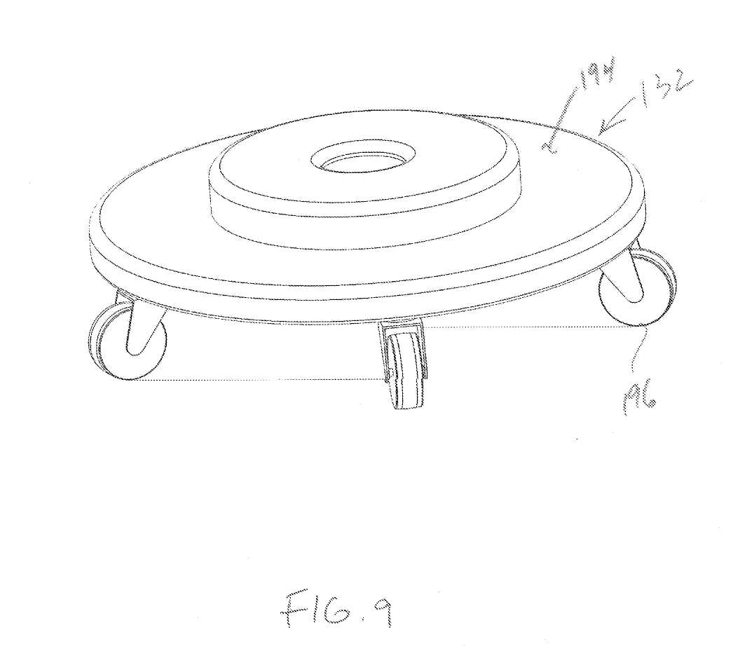

In FIG. 9, a dolly 132 is shown. As shown, the dolly 132 may be configured to allow the bin 130 to be rolled into and out of the compaction receptacle 100 while also allowing the bin 130 to be rotated when it is within the compaction receptacle 100. As shown, the dolly 132 may include a bin engaging plate or element 194. The bin engaging plate or element 194 may include a substantially flat upper surface to allow the bin to rest thereon. In one or more embodiments, the bin engaging plate may have a texture or a series or raised and recessed areas creating a contour matching that of a bottom of a bin so as to nestingly engage the bottom of the bin and resist relative lateral motion of the bin and the dolly. As shown, the bin engaging plate may include a substantially flat annular area around the outside of the plate and a raised annular area near the inside of the plate. The dolly may include one or a series of casters 196 arranged around the bottom of the dolly to rollingly support the bin engaging plate. The casters 196 may be pivotable about a vertical axis allowing the dolly 132 to be rolled in a selected direction and/or allowing the dolly to be pivoted or spun, for example.

The present compaction receptacle may include a series of sensors for monitoring and managing the trash compaction. In one or more embodiments, the sensors may include sensors for monitoring the depth or height of trash in the front half of the bin. In one or more embodiments, the sensors may include sensors for determining when the compacted trash is up to the retracted height of the ram indicating that a change may be required. The sensors may include sensors door opening or latch disengaged sensors to prevent operation of the unit in an open condition. Other sensors may include pressure sensors to avoid overly powerful compaction strokes or sensors to monitor power, for example. As discussed, a sensor may be provided in the way of a light curtain to avoid operation when extremities may be at or near the trash receiving opening. Still other sensors and devices may be provided. In particular, and based on the method below, one or more sensors may be provided to accommodate and provide inputs for the method described.

In use, the compaction receptacle may be placed in a private, semi-private, or public venue where trash collection is desired. Users may place trash in the receptacle and the receptacle may regularly, periodically, or continuously compact the trash placed in the receptacle. The trash may be generally placed and collected in a front half of the bin because the trash receiving opening may be arranged above the front half of the bin and because the backstop may guide trash or debris into the front half of the bin. A sensor may be provided to monitor the height of the trash in the bin such that the height of the trash is prevented from exceeding a bottom edge of the ram, for example. When the trash is accumulated to a selected height in the front half of the bin, for example, the bin may be rotated such that the trash/debris in the front half of the bin is rotated below the ram in the back half of the bin. The rotation may occur by actuating the drive wheel for a time and at a rate such that the bin is rotated approximately one half turn. Upon completion of the rotation, the compactor portion of the head may actuate the ram to compact the trash/debris that is now below the ram. The ram may extend downwardly by a distance and with a force to compact the trash/debris. It is to be appreciated that during the compaction cycle, further trash/debris may be placed into the receptacle because the trash receiving opening may remain open and placement of trash/debris into the front half of the bin may not interfere with the compaction cycle. Moreover, a hold down force may be created by the ram and the hold down force may be maintained for a period of time thereby more efficiently compacting the trash/debris. The ability to continue to receive trash during this hold down period may be a further advantage of the present receptacle due to avoidance of interrupted feeding of trash and, thus, allowing the hold down force to be held as desired by the user and/or the designer. The hold down force may be imparted on the compacted trash for periods of time ranging from 1 minute, 5 minutes, 10 minutes, 15 minutes, 20 minutes, 30 minutes, or an hour, for example. Still other time periods may be selected. For example, in some embodiments, the compaction head may be configured to provide a hold down force unless and until the other half of the bin is full and needs to be compacted.

After the hold down period, the ram may release the compaction force and retract up an into the bin-accommodating housing of the compactor portion. The cycle may be repeated by continuing to monitor the amount of trash/debris in the front half of the bin and rotating the trash to a position below the compactor when a particular amount of trash has been received. When the compacted trash reaches the height of the compactor ram in both the front and back half of the bin, the receptacle may indicate that the bin is in need of a change. Nonetheless, the receptacle may continue to be available to users for trash placement while it is awaiting a change of the trash.

It is to be appreciated that while the present disclosure has focused on a front half and a back half of the bin, other increments of the bin may be utilized. For example, the bin may be divided into thirds, fourths, fifths, sixths, and the like and the ram size and/or the rotation amount may be adjusted to accommodate a system configured for compaction in increments consistent with the selected division.

In one or more embodiments, the bin may be divided into sections for collecting particular types of garbage or debris. For example, some areas may be for trash while other areas may be recycling or particular type of recycling such as aluminum, glass, or paper, for example. The content of U.S. application Ser. No. 14/600,729 entitled compaction receptacle, filed on Jan. 20, 2015 is hereby incorporated by reference herein in its entirety.

Several features of the compaction receptacle may provide one or more of the following advantages:

Continuous Feed—The compaction head may compact in the back half of the bin allowing trash to be received by the bin during compaction. Moreover, if the bin is considered full, which may be a situation where trash has reached the height of the compaction head, the receptacle may continue to be used as a conventional waste receptacle allowing the system to remain in service even when indicating that a change is due.

Standard can/bag/dolly—The compaction receptacle may be configured to receive a standard waste can or waste bin allowing the compaction receptacle to seamlessly replace current waste receptacles by replacing the current receptacle housing with the compaction receptacle described and shown herein. In some cases, current users of waste cans or waste bins position the bins on dollies that have wheels or rollers for easily transporting the bin. The current design allows for the bin and the dolly to be used as part of current compaction receptacle.

Pivot Hood—As shown in the figures, the hood of the compaction receptacle may pivot upward allowing for easy access to the compaction head for cleaning. Still further, the door on the front of the compaction receptacle may open and close allowing for additional access to the inside of the machine for cleaning. In some embodiments, the order in which the hood and the front door of the receptacle are closed does not need to occur in a particular order; the front door or the hood may be closed first and still allow the other to close afterward.

The pivoting hood may be configured to automatically open such as by using hydraulic cylinders, a torsion bar, a spring, or other upward biasing devices or systems.

Rotation of head into can—The compaction head of the compaction receptacle may rotate into the can saving considerable space and allowing for the height of the system to be the same or similar to the height of common waste receptacles. Moreover, this approach may cause an indication of “full” sooner than if the head was positioned higher and, as such, may allow for emptying of the receptacle at a point where the weight of the trash is more manageable.

Rotate can—The bin may be configured to rotate via engagement by a rotation roller. The rotation roller may engage the side of the bin and rotate a first direction causing the bin to rotate the opposite direction. The rotation of the bin may allow trash to be rotated beneath the compaction head and may expose an empty portion of the bin or previously compacted trash to the user for addition of more trash.

½ area=more pressure per input force—The compaction head may be sized to compact a portion of the bin, such as ½ the area of the bottom of the bin. The smaller footprint of the compaction head may allow for more pressure per input force on the trash.

Light curtain—a light curtain may be provided for added safety during the continuous feed process. That is, as mentioned, the compaction receptacle may be configured to compact while also continuing to receive trash from the users. Accordingly, at or just below the trash receiving opening of the receptacle, a sensor, light curtain, or other sensing device may be provided such that if a user's extremity such as a hand or arm is in the compactor, the compactor will halt or avoid moving altogether.

Hold down—The continuous feed option allows the compaction head to impart a hold down force on the compacted trash for an extended period of time. That is, since feeding of the machine is not interrupted by compaction cycles, the compaction head may be configured to provide a hold down force on the trash while the receptacle is still being used by being filled with trash. This hold down approach may substantially increase the compaction rate of the trash. In some embodiments, the compaction head may be configured to provide a hold down force unless and until the other half of the bin is full and needs to be compacted.

Top of unit tight to top of can—the top of the unit may be substantially close in proximity to the top of the trash bin. This may help to prevent trash from being deposited within the receptacle but outside of the bin. This feature may also contribute to a substantially compact design.

The compaction head may be a hydraulic or telescoping head, which may move at a relatively fast or a relatively slow rate.

It is to be appreciated that the presently disclosed compactor may be advantageous for several reasons. That is, the proximity of the top of the trash bin to the compaction head may be very close and a portion of the compaction head may actually be positioned within the bin when bin is in a compaction position. In other known compaction receptacles, the compaction head may be positioned above and spaced away from the bin such that incoming trash may pass below the compaction head and into the bin. This creates a larger device due to the need to maintain space between the head and the bin. This ability to maintain the close proximity of the compaction head to the bin may be provided by the ability to articular or move the trash bin out from beneath the compaction head. Moreover, as mentioned, the full containment of the system and maintaining of movement within the housing may help to prevent damage to the unit through user manipulation of the trash bin. Still other advantages are present with the presently disclosed system.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A compaction capable receptacle, comprising:
a housing with a trash receiving opening;
a compaction unit arranged within the housing;
a trash bin arranged within the housing and configured for rotating trash within the bin below the compaction unit.

2. The receptacle of claim 1, wherein the receptacle is configured for continuous feed operation.

3. The receptacle of claim 1, wherein the compaction unit is configured for hold down.

4. The receptacle of claim 3, wherein the compaction unit is configured to continue receiving trash during the hold down operation.

5. The receptacle of claim 1, wherein the compaction unit is configured for arrangement partially within the trash bin.

6. The receptacle of claim 5, wherein the compaction unit is pivotable into and out of the trash bin.

7. The receptacle of claim 6, wherein the compaction unit is biased in a position out of the trash bin.

8. The receptacle of claim 1, further comprising a drive wheel configured for rotating the trash bin within the housing.

9. The receptacle of claim 8, further comprising a plurality of guides for guiding the rotation of the trash bin within the housing.

10. The receptacle of claim 9, wherein the compaction unit comprises a bin-accommodating housing configured for guiding the rotation of the trash bin.

11. The receptacle of claim 1, wherein the compaction unit is arranged in substantially a back half of the trash bin.

12. The receptacle of claim 11, wherein the trash bin is configured to rotate approximately 180 degrees to position trash below the compaction unit.

13. The receptacle of claim 12, wherein the compaction unit is configured to hold down pressure on the trash until a front half of the trash bin needs compaction.

14. The receptacle of claim 1, further comprising a door for removal of the trash bin.

15. The receptacle of claim 14, wherein the door is coupled to the compaction unit and the compaction unit is biased in an upward direction such that opening the door frees the compaction unit to rotate upwardly and out of the trash bin.

16. A method of receiving and compacting trash, comprising:
receiving trash into a bin through a trash receiving opening;
guiding the trash to a front half of the bin;
rotating the trash in the front half of the bin below a compaction unit;
compacting the trash; and
simultaneously receiving additional trash into the bin.

17. The method of claim 16, wherein compacting the trash further comprises imparting a hold down force.

18. The method of claim 17, further comprising interrupting the compacting when a light curtain is interrupted.

19. The method of claim 16, wherein rotating the trash comprises actuating a drive wheel to rotate the bin.

20. The method of claim 19, further comprising allowing for trash access by automatically pivoting the compaction unit upon opening of a door.
